(19) United States
(12) Patent Application Publication
(10) Pub. No.: US 2010/0156089 A1
(43) Pub. Date: Jun. 24, 2010

(54) End fitting for high pressure capillary tube

(76) Inventors: Yury Zelechonok, Northbrook, IL (US); Vladislav Orlovsky, Wheeling, IL (US)

Correspondence Address: JOHN C SHEPARD, 575 SUNSET ROAD, WINNETKA, IL, 60093, US

(21) Appl. No.: 12/317,271

(22) Filed: Dec. 22, 2008

(51) Int. Cl. F16L 35/00

(52) U.S. Cl. 285/24

(57) ABSTRACT

The fitting includes an elongated cylindrical body with a conical ferrule secured to its forward end, and with the body and ferrule having aligned through bores sized to allow a capillary tube to be passed through them. The elongated body has medially located external helical threads, and a knurled nut is rotatably coupled to these threads. The body also has elongated axially directed gripping fingers with inwardly facing gripping regions thereon normally spaced from but suited to be biased radially against the capillary tube in the fitting bores. A tubular gripping nut is threaded onto the external body threads, suited to be axially shifted along the body upon relative nut/body rotation. The nut and body have cooperating cam surfaces suited to engage upon relative nut/body rotation and bias the finger gripping regions tightly against the capillary tube for securely retaining tube as positioned within the fitting.

### BACKGROUND OF THE INVENTION

Capillary tubes, commonly used in high pressure liquid chromatogophry (HPLC) systems, must withstand 5000 psi pressures and up. To satisfy these demands, the capillary tubes typically are formed from an advanced polymer such as PEEK, or stainless steel. Fittings serve to removably connect the tube ends to columns and other components used in such systems, or elsewhere.

A typical fitting has been formed with an elongated one-piece body, with threads formed medially of the body and with an enlarged knurled gripping region formed rearwardly of the threads. A ferrule of PEEK is formed integrally with the body at its front end, or is formed separate and then mounted to the body front end. The body and ferrule have aligned through bores sized to allow a capillary tube to be fitted through both and to project forwardly beyond the ferrule.

A cooperating HPLC component 10 (see FIG. 5) would likewise have a conical cavity, but diverging at a wider angle than the tapered angle of the ferrule (possibly 40° versus 25°), operable to receive the ferrule when the fitting and component are connected together. This cooperation provides that when the fitting and component are finger tightened axially together, the ferrule nose is compressed and possibly even crimped inwardly against the capillary tube. This creates an annular (possibly even dimpled at the tube) sealing and holding region between the component, tube and ferrule (see FIG. 5a).

Although this dimpled region is relatively limited in size, it is the main and frequently the only means for not only sealing but also for holding the PEEK tube in the fitting. As such, the high operating pressures can overcome this limited sealing and holding capacity, whereby the tube can be axially blown out of the fitting, causing the system to fail.

### OBJECTS AND SUMMARY OF THE INVENTION

A basic object and summary of this invention is to provide additional securing structures, operable between the fitting and capillary tube, for yielding improved holding and sealing fitting performances.

A detailed object of the invention is to provide secondary gripping structures on the fitting that cooperate in a tandem manner with the conventional sealing and holding region for more securely holding a capillary tube and fitting together throughout the operating pressure range.

And more detailed object of the invention is to provide that these secondary gripping structures operate in a unique manner for more consistently holding the capillary tube and fitting operatively together throughout all pressure ranges, for improving the fitting performances.

### BRIEF DESCRIPTION OF THE SUBMITTED DRAWINGS

These and other objects, features and advantages of this invention will be more fully understood and appreciated after considering the following description of the invention, which includes as a part thereof the accompanying drawings, wherein:

FIG. 1 is a perspective view of a fitting according to this invention, with a capillary tube extended through it;

FIG. 2 is perspective view of a tube securing piece of said FIG. 1 fitting, operable to grip or release the capillary tube inserted through the fitting;

FIG. 3 is perspective view of a knurled nut used on the fitting to tighten or loosen it relative to the capillary tube;

FIG. 4 is a center section view of the nut of FIG. 3;

FIG. 5 is a center section view of the fitting shown operatively connected to a typical complementary component; and

FIGS. 5a and 5b are enlarged section views of the respective circled portions of FIG. 5.

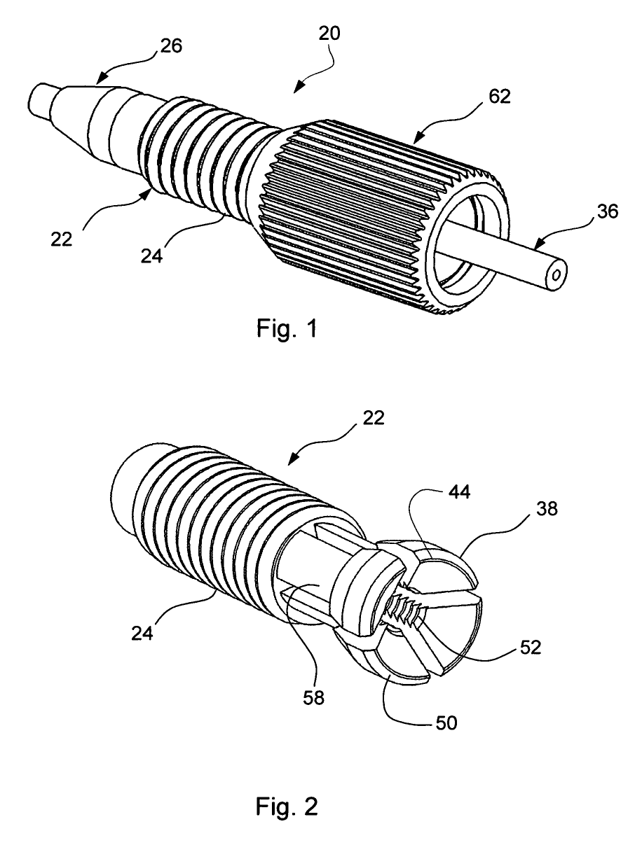

### DETAILED DESCRIPTION OF THE INVENTION

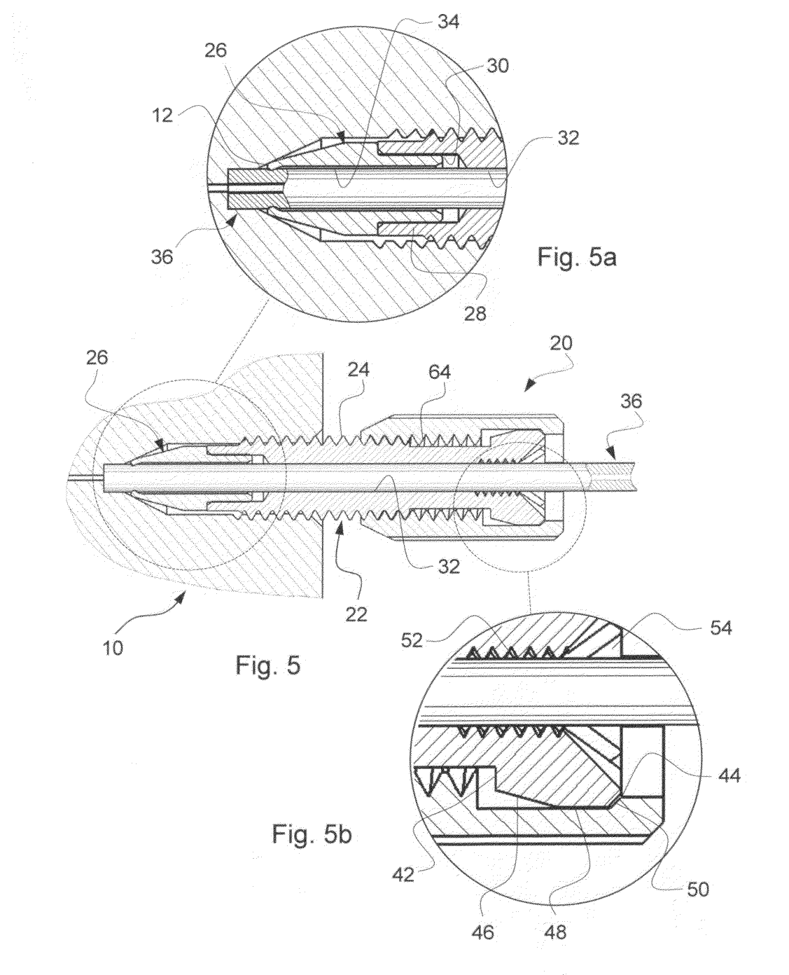

The inventive fitting 20 has an elongated body 22 having a medially located cylindrical portion with external helical threads 24 thereon. Further, a conical end ferrule 26 is on the forward end of the body, with its rear boss 28 (FIG. 5a) press fit into a forwardly open body cavity 30. The body 22 and ferrule 26 have aligned through bores 32, 34 sized to have capillary tube 36 passed through them.

The fitting body 22 is enlarged at its rearward end 38, sufficiently to extend radially beyond the threads 24. The enlarged rearward body end 38 is extended axially between a forward diametric face 42 and a rearward narrow annular face 44. The enlarged body end 38 extends radially to three peripherial surfaces 46, 48 and 50.

The middle body surface 48 is substantially cylindrical and defines the maximum radial size of the body end. The forward body surface 46 is extended between the front end of the middle surface 48 and forward diametric face 42. The rearward body surface 50 is extended between the rear end of the middle surface 48 and the narrow annular end face 44.

Abrasions, fine threads, or teeth 52 are formed on the inner surface of the body bore 32 near its rearward end, act as gripping regions that can be shifted to engage and hold an adjacent capillary tube 36.

A rearwardly expanding conical cavity 54 terminating at narrow annular end face 44 also is defined at the rear end of the enlarged body, to help guide the capillary tube into the bore 32.

The enlarged body 38 is connected to the front of the body across a reduced diameter stem-like portion radially smaller than the threads.

Each of the body surfaces 42, 44, 46, 48, 50, the teeth 52, and stem portion is formed to be generally concentric of the body bore 32 and fitting threads 24.

The body might be formed of metal, such as stainless steel, and be machined from a solid piece to the configuration as noted. Thereafter, axial cross cuts can be made in from the rearward end, which converts the previously solid enlarged body 38 and stem portion into four fingers 58 each having parts of the previously noted surfaces and formations. The fingers 58 can be radially flexed somewhat to allow minor movements of the rearward finger ends and gripping teeth 52 thereon into the body through bore 32.

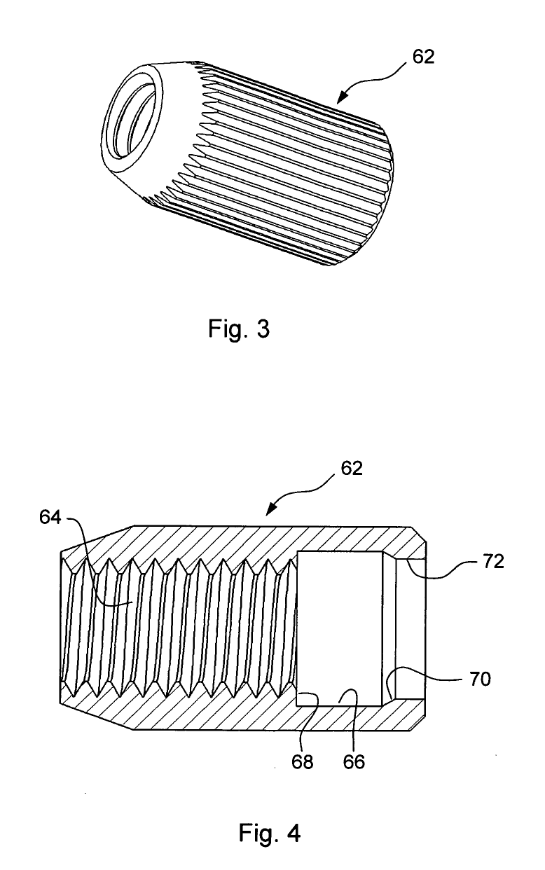

An externally knurled tubular nut 62 (FIGS. 3 and 4) has a through bore with forward helical threads 64 suited to cooperate with the threads 24 on the fitting body 22. A cavity 66 is formed in the nut at the rearward end of the threads 64, axially extending between diametric face 68 and conical cam face 70 bordering the nut end opening 72. The cavity 66 is sized large enough to freely receive the enlarged rear body end 38.

The body cam face 50 and the nut cam face 70 are angled the same, such at possibly 10-40 degrees off of the central body and nut axes, and they normally match up generally flush against one another (see FIG. 5b).

With the capillary tube 36 removed from the body 22, the nut and body can be assembled together by inserting the ferrule 26 through the nut opening 72 and by relative nut/body rotation suited to advance the enlarged body portion to butt the body cam 46 against the rear edge of the nut opening 72. Continued relative nut/body rotation will flex the body fingers inwardly to allow the enlarged body portion 38 to pass through the nut opening and emerge into the nut cavity 66.

Once in the cavity, the body portion 38 is restricted to limited axial movement, between diametric body wall 42 hitting the cavity wall 68 and the body cam face 50 hitting nut face 70. Upon nut/body rotation causing these body and nut faces to hit, continued rotation is possible with the body 22 and nut 62 being rotated as a unit, such as to thread the fitting into or from the cooperating HPLC component (see FIG. 5).

Thus, with the capillary tube 36 positioned in the fitting 20 and the fitting loosely threaded into any complementary or cooperating component, finger tightening nut rotation will bias the ferrule 26 into the component (see FIG. 5) to compress and possibly even crimp the ferrule nose inwardly against the capillary tube 36 to establish the conventional sealing and holding region between the component, tube and ferrule region. The tightening nut rotation will simultaneously cause the cam surfaces 50, 64 to engage and shift the fingers radially inward to exert binding pressures between the finger gripping regions 52 and capillary tube, thereby establishing tandem means for securing the capillary tube in place in the fitting. Thus, the blow-out problems encountered prior to this improvement will be eliminated.

As the fitting body 22 and nut 62 are substantially keyed together, the capillary tube 36 can be removed from the fitting by finger turning the nut in the loosening direction to release the gripping fingers from holding contact therewith. Continued nut loosening will ultimately remove the fitting from the cooperating HPLC component.

1. A fitting for a high pressure capillary tube, suited for releasably securing and sealing the tube relative to a high pressure liquid chromatography component, comprising
an elongated partly cylindrical body having forward and rearward ends and medially located external helical threads;
a conical end ferrule secured to the forward end of the body;
said body and ferrule having aligned through bores sized to have the capillary tube passed therethrough;
said body having elongated gripping fingers with flexible free ends extending axially of the rearward end and with radially inward gripping regions near the finger free ends;
said gripping regions normally being spaced apart to allow said capillary tube to be inserted into the body bore adjacent said gripping regions;
a tubular nut having forward and rearward end openings and internal threads adapted to cooperate with the external body threads for axially shifting said nut along the body; and
cam surfaces on the nut and fingers suited to engage and bias the gripping regions radially inward tightly against the capillary tube for retaining it positioned within the fitting.

2. A fitting according to claim 1, further including said nut having a cavity in part defined by one of said cam surfaces and extending radially beyond the threads of the body, and said body having an enlarged portion positioned in the cavity and defining the other of said cam surfaces, and said cam surfaces being engaged upon the nut being shifted axially along the body operable for biasing the gripping regions tightly against the capillary tube.

3. A fitting according to claim 1, further including said gripping fingers defining an enlarged body portion with a sloped cam surface having one end smaller and the other end larger than the rearward end opening of the nut, suited upon relative nut/body rotation and the sloped body portion cam surface engaging the nut at its rearward end opening to flex the fingers to fit the enlarged body portion into the nut.

4. A fitting according to claim 3, further including said nut having a cavity in part defined by one of said cam surfaces and extending radially beyond the threads of the body, and said body having an enlarged portion positioned in the cavity and defining the other of said cam surfaces, and said cam surfaces being engaged upon the nut being shifted axially along the body operable for biasing the gripping regions tightly against the capillary tube.

5. A fitting for a high pressure capillary tube, suited for releasably securing and sealing the tube relative to a high pressure liquid chromatography component, comprising
an elongated partly cylindrical body having forward and rearward ends and medially located external helical threads;
a conical end ferrule secured to the forward end of the body;
said body and ferrule having aligned through bores sized to have the capillary tube passed therethrough;
said body having circumferentially spaced, elongated gripping fingers with flexible free ends extending axially of the rearward end and with radially inward gripping regions near the finger free ends;
said gripping regions normally being spaced apart to allow said capillary tube to be inserted into the body bore adjacent said gripping regions;
a tubular nut having forward and rearward end openings and internal threads adapted to cooperate with the external body threads for axially shifting said nut along the body;
said gripping fingers defining an enlarged body portion with a sloped cam surface having one end smaller and the other end larger than the rearward end opening of the nut, suited upon relative nut/body rotation and the sloped cam surface engaging the nut at its rearward end opening to flex the fingers to fit the enlarged body portion into the nut cavity;
cam surfaces on the nut and fingers suited to engage and bias the gripping regions radially inward tightly against the capillary tube for retaining it positioned within the fitting as the nut is shifted axially along the body; and
said nut having a cavity in part defined by the cam surface on the nut and extending radially beyond the threads of the body, and the body having its enlarged portion positioned in the cavity and defining the cam surface on the fingers.
